(19) United States
(12) Patent Application Publication
(10) Pub. No.: US 2015/0116092 A1
(43) Pub. Date: Apr. 30, 2015

(54) GIRTH MEASURING DEVICE AND METHOD FOR MEASURING GIRTH OF TREE, AND WIRELESS COMMUNICATION TAG APPARATUS INCLUDING GIRTH MEASURING DEVICE

(71) Applicant: ELECTRONICS AND TELECOMMUNICATIONS RESEARCH INSTITUTE, Daejeon (KR)

(72) Inventors: Hoe Sung YANG, Daejeon (KR); Chan Won PARK, Daejeon (KR)

(21) Appl. No.: 14/524,511

(22) Filed: Oct. 27, 2014

(30) Foreign Application Priority Data
Oct. 29, 2013 (KR) 10-2013-0128994

(51) Int. Cl. G06K 7/10; G01B 5/00

(52) U.S. Cl. CPC G06K 7/10366; G01B 5/0035; G01B 2210/58
USPC 340/10.4; 33/555.4

(57) ABSTRACT

A wireless communication tag apparatus including a girth measurement device and a wireless communication tag method are disclosed. The wireless communication tag apparatus and method measures a girth of a tree using an unwound length of a tape wound around a trunk of the tree according to growth of the tree, and transmits the girth to a wireless communication reader.

### CROSS-REFERENCE TO RELATED APPLICATION

This application claims the benefit of Korean Patent Application No. 10-2013-0128994, filed on Oct. 29, 2013, in the Korean Intellectual Property Office, the disclosure of which is incorporated herein by reference.

### BACKGROUND

1. Field of the Invention

The present invention relates to a wireless communication tag apparatus including a girth measurement device for tree girth measurement and a wireless communication tag method, and more particularly, to a wireless communication tag apparatus for measuring a tree girth increasing with growth of the tree and a girth measurement device included in the wireless communication tag apparatus.

2. Description of the Related Art

To measure a girth of a tree according to growth of the tree, conventionally, a person used to directly measure the girth using a measuring tape at a predetermined period. The tree may be attached with an identifier (ID) mark, for example, in the form of a paper or plastic piece recording a planting date and an ID of the tree. Therefore, by identifying the tree through the ID mark hanging on or attached to the tree, the person may measure the tree girth and manage the corresponding tree based on the measured girth.

Recently, trees are managed using a communication device. That is, a radio frequency ID (RFID) tag recording an ID, a planting date, a species, and the like of a tree is fixed to individual trees, and data related to growth of the tree is managed by recognizing the species and the planting date by a reader associated with the RFID tag. However. the RFID tag may provide only a disease history, a place, a lifespan, and a growth distribution, but not information on a girth of the tree. Therefore, the girth according to growth of the tree needs to be separately measured by a person.

### SUMMARY

An aspect of the present invention provides a wireless communication tag apparatus and method, the wireless communication tag apparatus including a girth measurement device that efficiently measures a girth of a tree according to growth of the tree without demanding a separate process of measuring the girth from a person, by including the girth measurement device for automatically measuring the girth of the tree and measuring the girth based on a predetermined measurement period and storage period.

Another aspect of the present invention provides a wireless communication tag apparatus and method, the wireless communication tag apparatus including a girth measurement device capable of managing a growth speed and a growth degree of a tree according to growth of the tree, by obtaining a tree girth measured by the wireless communication tag apparatus through a wireless communication reader operating in association with the wireless communication tag apparatus.

According to an aspect of the present invention, there is provided a wireless communication tag apparatus including a girth measurement device to measure a girth of a tree using an unwound length of a tape wound around a trunk of the tree, the tape unwound according to growth of the tree, and a wireless communication device to transmit the measured girth to a wireless communication reader.

The wireless communication tag apparatus may further include a winder to rewind the tape when the tape is unwound from the trunk of the tree according to growth of the tree while maintaining a constant tension of the tape, and a calculator to calculate the girth of the tree based on the unwound length of the tape.

The girth measurement device may include a tape adapted to be wound around the trunk of the tree. One side of the tape may be connected to the winder, and another side of the tape may be connected to the wireless communication tag apparatus.

The calculator may determine a number of winding of the winder according to the unwound length of the tape and convert the number of winding into a growth length of the tree.

The calculator may determine the number of winding of the winder based on a girth of the winder measured with reference to a starting position of winding of the tape on the winder.

The girth of the tree may be periodically measured according to a growth speed of the tree, and the measured girth of the tree may be used as information to manage a growth process of the tree.

The wireless communication device may transmit the measured girth of the tree in response to at least one of a transmission period included in girth measurement setup information set when the wireless communication tag apparatus is attached to the tree and a transmission command of the wireless communication reader.

According to another aspect of the present invention, there is provided a girth measurement device including a winder to rewind a tape wound around a trunk of a tree when the tape is unwound from a wireless communication tag apparatus to measure a girth of the tree, while maintaining a constant tension of the tape, and a calculator to calculate the girth of the tree based on an unwound length of the tape.

The tape may be wound around the winder by a first length and around the tree by a second length.

The first length may refer to a length of the tape provided to be wound around the trunk according to a growth of the tree, and the second length may refer to a length of the tape wound around the trunk according to the growth of the tree and unwound to calculate the girth of the tree.

The calculator may determine a number of winding according to the unwound length of the tape and convert the number of winding into a growth length of the tree.

The calculator may determine the number of winding of the winder based on a girth of the winder measured with reference to a starting position of winding of the tape on the winder.

The girth of the tree may be periodically measured according to a growth speed of the tree, and the measured girth of the tree may be used as information to manage a growth process of the tree.

The girth measurement device may be built in the wireless communication tag apparatus, and the wireless communication tag apparatus may transmit a growth length of the tree to a wireless communication reader.

According to another aspect of the present invention, there is provided a girth measurement method including allowing a tape wound around a trunk of a tree to be unwound from a wireless communication tag apparatus to measure a girth of the tree while maintaining a constant tension of the tape, determining a number of winding of a winder according to an unwound length of the tape, and calculating the girth based on the number of winding.

The tape may be wound around the winder by a first length and around the tree by a second length.

The first length may refer to a length of the tape provided to be wound around the trunk according to a growth of the tree, and the second length may refer to a length of the tape wound around the trunk according to the growth of the tree and unwound to calculate the girth of the tree.

The calculating of the girth may include converting the number of winding into a growth length of the tree based on the number of winding.

The girth measurement device may determine the number of winding of the winder based on a girth of the winder measured with reference to a starting position of winding of the tape on the winder.

The girth of the tree may be periodically measured according to a growth speed of the tree, and the measured girth of the tree may be used as information to manage a growth process of the tree.

### EFFECT

According to embodiments of the present invention, a wireless communication tag apparatus including a girth measurement device and a wireless communication tag method to may efficiently measure a girth of a tree according to growth of the tree without demanding a separate process of measuring the girth from a person, by including the girth measurement device for automatically measuring the girth of the tree and measuring the girth based on a predetermined measurement period and storage period.

Additionally, according to embodiments of the present invention, a wireless is communication tag apparatus including a girth measurement device and a wireless communication tag method may manage a growth speed and a growth degree of a tree according to growth of the tree, by obtaining a tree girth measured by the wireless communication tag apparatus through a wireless communication reader operating in association with the wireless communication tag apparatus.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating an overall flow of a wireless communication tag apparatus according to an embodiment of the present invention;

FIG. 2 is a diagram illustrating a configuration of a wireless communication tag apparatus according to an embodiment of the present invention;

FIG. 3 is a diagram illustrating a combination structure of a wireless communication tag apparatus and a girth measurement device, according to an embodiment of the present invention;

FIG. 4 is a diagram illustrating a configuration of a girth measurement device according to an embodiment of the present invention;

FIG. 5 is a flowchart illustrating a wireless communication tag method according to an embodiment of the present invention; and

FIG. 6 is a flowchart illustrating a girth measurement method according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout.

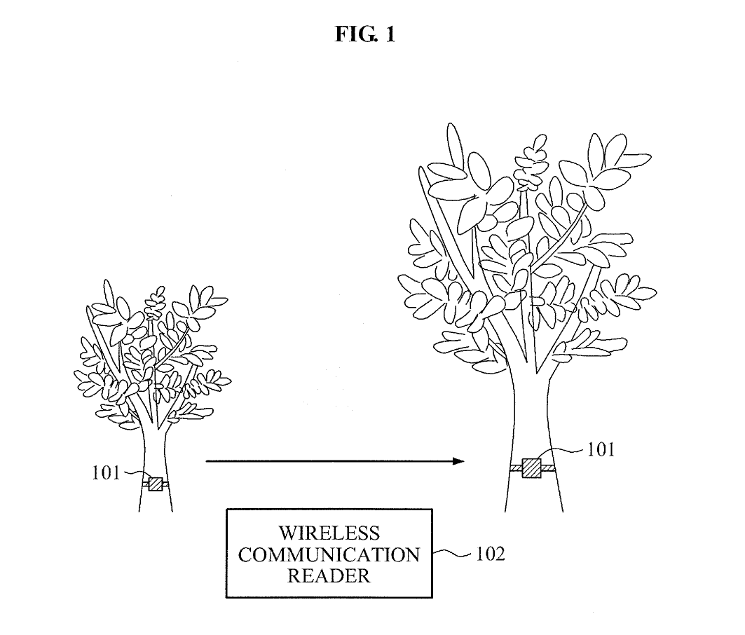

FIG. 1 is a diagram illustrating an overall flow of a wireless communication tag apparatus 101 according to an embodiment of the present invention.

Referring to FIG. 1, the wireless communication tag apparatus 101 may be attached to a trunk of a tree to measure a girth of the tree according to growth of the tree. Here, the wireless communication tag apparatus 101 may be attached to a part of the trunk of the tree. Although not shown, the wireless communication tag apparatus 101 may separately include a girth measurement device for measuring the girth of the tree. The girth measurement device may include a tape adapted to be wound around the trunk.

The trunk may be wound by the tape of the wireless communication tag apparatus 101. The wireless communication tag apparatus 101 may measure the girth through extension of the tape wound around the trunk according to growth of the tree. For example, the wireless communication tag apparatus 101 may measure the girth according to growth of the tree, by measuring an increased length of the tape increased with growth of the tree.

When the wireless communication tag apparatus 101 is attached to the trunk, girth measurement setup information including a period of measuring the girth, a period of transmitting the measured girth, a target value of the girth, and the like may be predetermined. The girth measurement device 101 may measure, transmit, and store the girth based on the predetermined girth measurement setup information.

In addition, the girth measurement device 101 may transmit the measured girth corresponding to a girth transmission command of the wireless communication reader 102 operating in association with the wireless communication tag apparatus 101. The wireless communication reader 102 may manage growth information of the tree by obtaining the girth measured by the wireless communication tag apparatus 101. The wireless communication reader 102 may be a portable type or fixed type but not limited thereto.

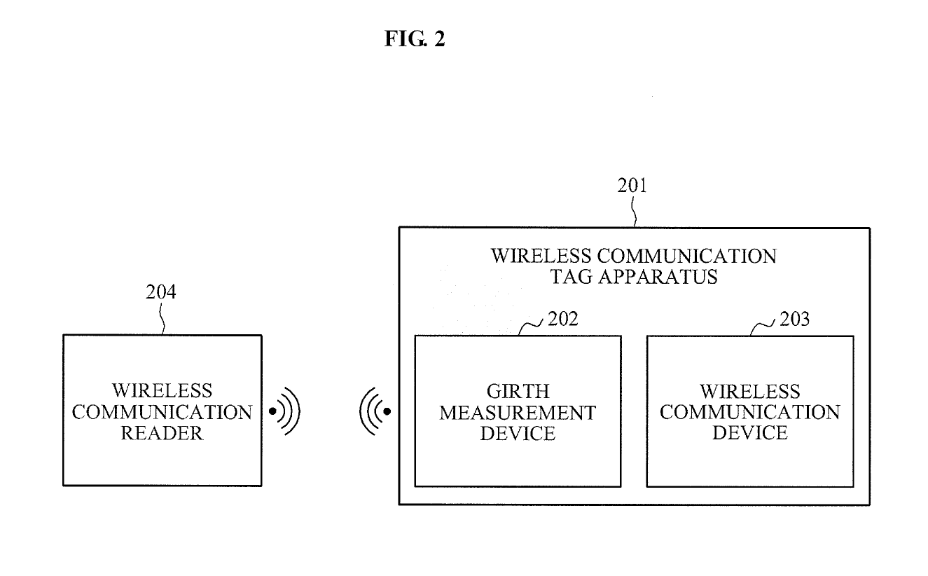

FIG. 2 is a diagram illustrating a configuration of a wireless communication tag apparatus 201 according to an embodiment of the present invention.

Referring to FIG. 2, the wireless communication tag apparatus 201 may include a girth measurement device 202 and a wireless communication device 203. The wireless communication tag apparatus 201 may perform wireless communication with a wireless communication reader 204 using the wireless communication device 203.

Specifically, the wireless communication tag apparatus 201 may measure a girth of a tree using the girth measurement device 202 based on girth measurement setup information related to a predetermined tree girth. The wireless communication tag apparatus 201 may measure the girth of the tree through the girth measurement device 202 based on the girth measurement setup information. The girth measurement device 202 may measure the girth based on an unwound length of a tape which is wound around a trunk of the tree and unwound according to growth of the tree. The girth measurement device 202 may include the tape adapted to be wound around the trunk. One end of the tape may be fixed to the girth measurement device 202 while the other end of the tape is connected to a part of the wireless communication tag apparatus 201. The other end of the tape may include an additional tool for connection with the part of the wireless communication tag apparatus 201. For example, a link may be provided to the other end of the tape and connected with the part of the wireless communication tag apparatus 201. However, various other tools besides the link may be provided to the other end of the tape. In addition, the wireless communication tag apparatus 201 may include a tool for connection with the other end of the tape. For example, the wireless communication tag apparatus 201 may include a link hole to be engaged with the link of the other end of the tape.

The wireless communication tag apparatus 201 may measure the girth using the girth measurement device 202 and transmit the measured girth to the wireless communication reader 204 through the wireless communication device 203. For example, the wireless communication tag apparatus 201 may transmit the measured girth to the wireless communication reader 204 according to a predetermined transmission period or when the girth reaches a predetermined target value. Alternatively, the wireless communication tag apparatus 201 may transmit the measured girth to the wireless communication reader 204 in accordance with a command from the wireless communication reader 204 to transmit a recently measured girth or a currently measured girth.

Since the wireless communication tag apparatus 201 transmits the girth to the wireless communication reader 204 at the predetermined transmission period, the wireless communication reader 204 may manage the periodically measured girth according to growth of the tree.

The wireless communication reader 204 may also manage a growth degree of the tree based on the girth received at the predetermined transmission period from the wireless communication tag apparatus 201. For example, the wireless communication reader 204 may manage growth information on the growth degree according to a measurement period, based on a difference between a previously received girth and a currently received girth. Alternatively, the wireless communication reader 204 may manage girth values based on the girth at the time of measurement by checking a total length, for example in centimeters or meters, of the girth received at every measurement period.

The wireless communication reader 204 may match with the wireless communication tag apparatus 201 one to one or one to many. For example, when one wireless communication reader 204 and a plurality of wireless communication tag apparatuses 201 are provided, the wireless communication reader 204 may integratedly manage tree girths received from the plurality of wireless communication tag apparatuses 201. That is, the wireless communication reader 204 may receive the girths respectively from the plurality of wireless communication tag apparatuses 201 and perform integration management such as growth comparison among trees based on locations of the trees. The locations of the trees may be identified through location information of the wireless communication tag apparatuses 201.

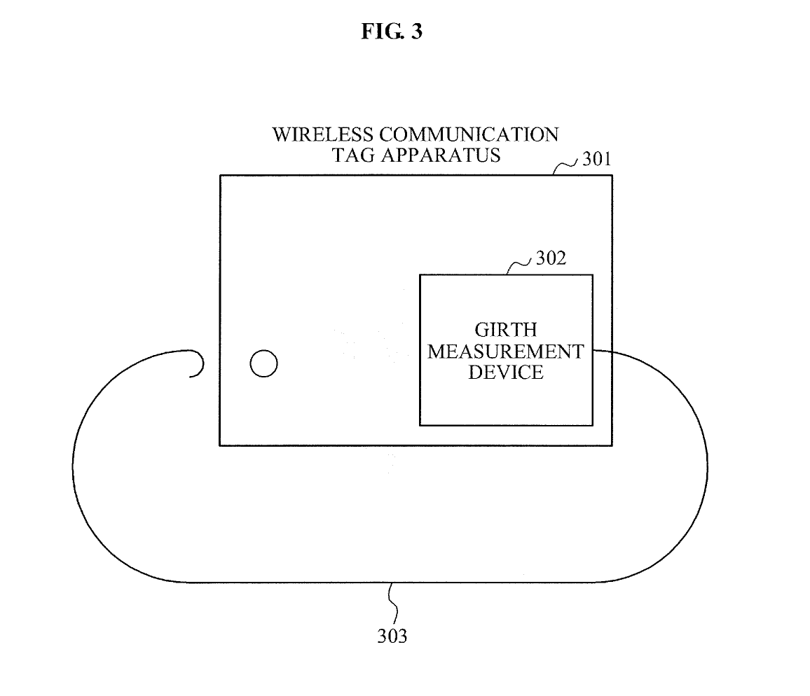

FIG. 3 is a diagram illustrating a combination structure of a wireless communication tag apparatus 301 and a girth measurement device 302, according to an embodiment of the present invention.

Referring to FIG. 3, the wireless communication tag apparatus 301 may include the girth measurement device 302. Here, the girth measurement device 302 may be internally or externally connected to the wireless communication tag apparatus 301. For example, the wireless communication tag apparatus 301 may include the girth measurement device 302 inside the wireless communication tag apparatus 301, or the girth measurement device 302 may be attached to an outside of the wireless communication tag apparatus 301. However, the wireless communication tag apparatus 301 and the girth measurement device 302 may be configured in various other manners rather than limited to the foregoing configuration.

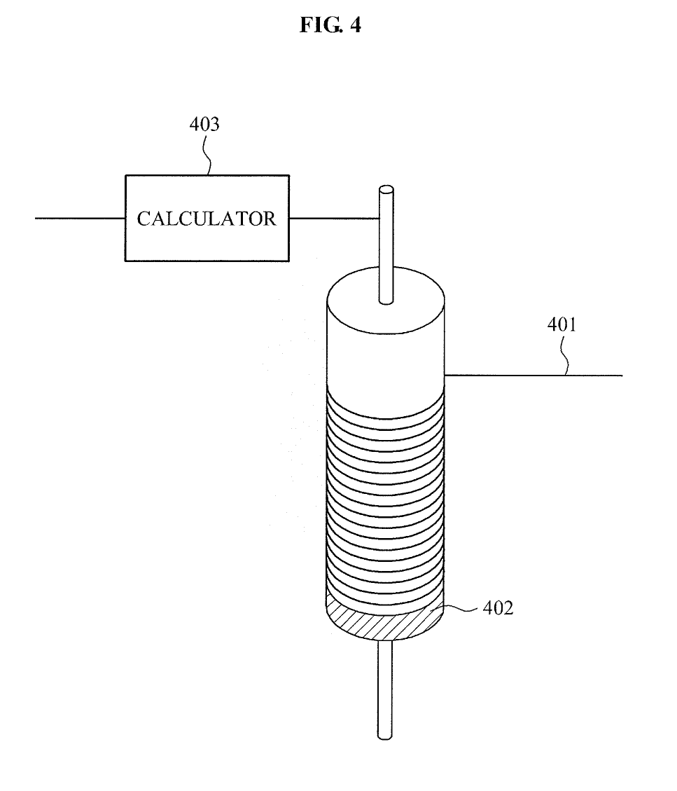

The girth measurement device 302 may separately include a tape adapted to measure a girth of a tree. The tape may be fixed to an inside of the girth measurement device 302. The fixing structure of the tape will be described in detail with reference to FIG. 4. The girth measurement device 302 may be connected to the wireless communication tag apparatus 301 through a link provided at an end of the tape opposite to the other end fixed to the girth measurement device 302. For example, the girth measurement device 302 may wind around a trunk of the tree using the tape as the link provided at the end of the tape is engaged with a link hole formed at a part of the wireless communication tag apparatus 301.

FIG. 4 is a diagram illustrating a configuration of a girth measurement device according to an embodiment of the present invention.

Referring to FIG. 4, the girth measurement device may include a winder 402, a calculator 403, and a tape 401 winding on the winder 402. The girth measurement device may be adapted to measure a girth of a tree using the tape 401.

The winder 402 may have a rewind function of the tape 401 to maintain a constant tension of the tape 401 when the tape 401 wound around a trunk of the tree is unwound according to growth of the tree. In a state in which a link of the tape 401 is engaged with a wireless communication tag apparatus, the winder 402 may unwind the tape 401 as the tree grows so that the tape 401 winds around the girth.

The tape 401 may be wound around the winder 402 by a first length and around the tree by a second length. The first length may refer to a length of a spare tape for measuring the girth according to growth of the tree. The second length may refer to a length of the tape 401 wound around the trunk with growth of the tree. The first length and the second length may be changed depending on circumstances.

The winder 402 may automatically rewind the unwound tape 401 when the link of the tape 401 is separated from the wireless communication tag apparatus. In addition, the winder 402 may maintain the constant tension of the tape 401 when the tape 401 is extended according to growth of the tree and pulled by the winder 402. For example, when the link provided to one end of the tape 401 is separated from a link hole provided to the wireless communication tag apparatus, the winder 402 may automatically rewind the tape unwound as long as the girth.

The calculator 403 may calculate the girth of the tree based on the unwound length of the tape. That is, the calculator 403 may determine a number of winding of the winder 402 according to the unwound length, and convert the number of winding into a growth length of the tree. For example, the calculator 403 may convert the number of winding into the growth length based on a girth of a cylinder of the winder 402 according to the number of winding. That is, the cylinder girth may be calculated with reference to a starting position of winding of the tape on the cylinder. The calculator 403 may measure the unwound length of the tape with reference to the starting position.

When it is not a time corresponding to the measurement period according to the girth measurement setup information, the girth measurement device may wind around the girth while unwinding the tape 401 off the winder 402. When the girth is measured since it is the time corresponding to the measurement period, the link may be separated from the wireless communication tag apparatus and the tape 401 may be rewound until a spot for measuring the girth. Accordingly, the girth of the tree may be calculated.

When the girth measurement is completed, the tape 401 rewound on the girth measurement device may be connected again to the wireless communication tag apparatus, by a user or as the tape 401 is unwound off the winder 402.

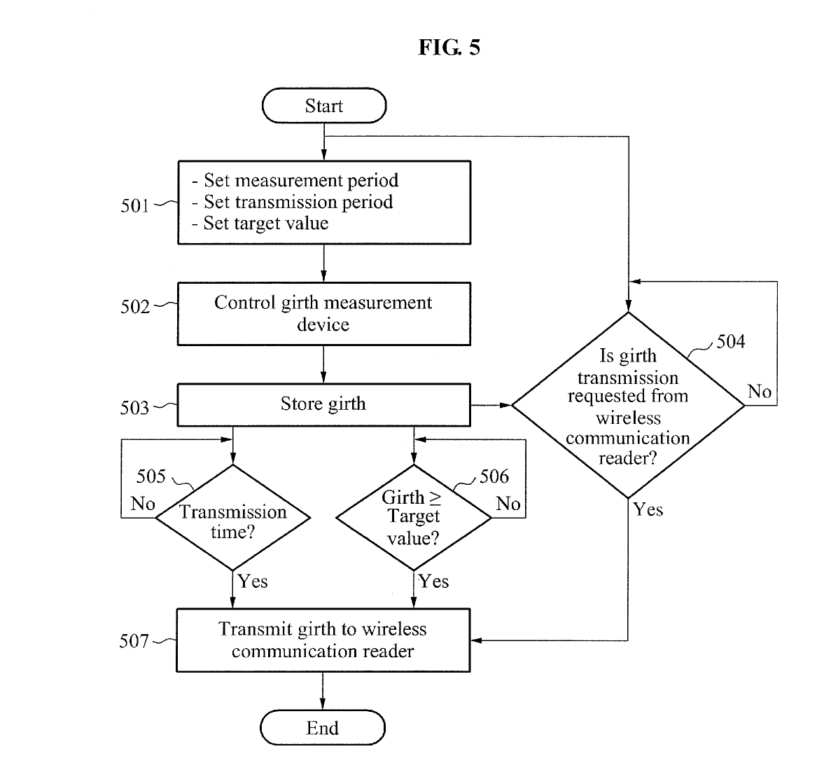

FIG. 5 is a flowchart illustrating a wireless communication tag method according to an embodiment of the present invention.

In operation 501, girth measurement setup information for measurement of a girth of a tree according to growth of the tree may be set in a wireless communication tag apparatus. That is, when the wireless communication tag apparatus is attached to a tree to be measured, the girth measurement setup information such as a period of measuring the girth, a period of transmitting the measured girth, and a target value of the girth may be set in the wireless communication tag apparatus.

The girth measurement setup information may be set when the wireless communication tag apparatus is attached to the tree to enable the wireless communication tag apparatus to measure the girth at uniform periods and to transmit the measured girth to a wireless communication reader.

In operation 502, the wireless communication tag apparatus may control a girth measurement device to measure the girth based on the predetermined girth measurement setup information. For example, the wireless communication tag apparatus may measure the girth using a tape wound around a trunk of the tree according to a measurement period which is the period of measuring the girth.

In operation 503, the wireless communication tag apparatus may store the measured girth and operate according to the girth measurement setup information. That is, in operation 505, the wireless communication tag apparatus may determine whether it is a time corresponding to a transmission period which is the period of transmitting the girth. In operation 506, the wireless communication tag apparatus may determine whether the measured girth corresponds to the target value of the girth. In operation 504, the wireless communication tag apparatus may determine whether a transmission request according to a transmission command commanding transmission of the measured girth is received from the wireless communication reader.

Here, the wireless communication tag apparatus may transmit the girth measured according to operation 507 to the wireless communication reader when the girth measurement setup information is met in operations 504, 505, and 506.

The wireless communication tag apparatus may transmit the girth to the wireless communication reader corresponding to a particular event related to the girth. For example, although it is not the time corresponding to the measurement period. the wireless communication tag apparatus may determine cases in which the girth increases faster or slower than normal cases and may transmit the girth to the wireless communication reader.

To determine such cases, the girth measurement device may measure an unwound length of the tape unwound from a winder. For example, the girth measurement device may measure the number of winding of the tape with respect to the winder, thereby determining abnormality or a change in growth.

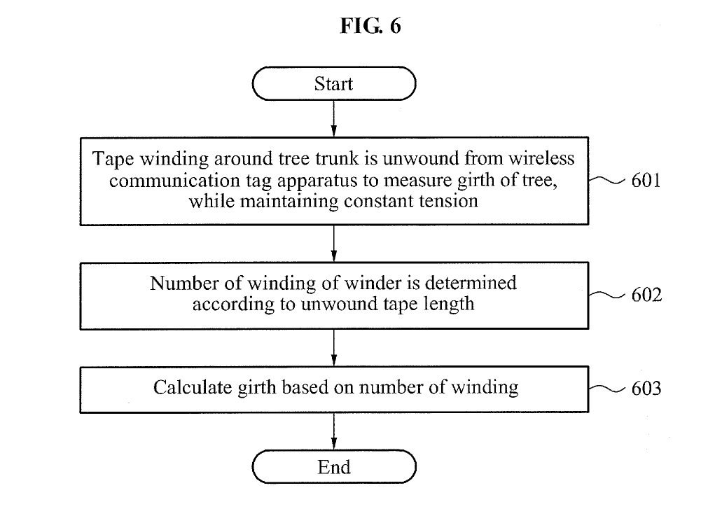

FIG. 6 is a flowchart illustrating a girth measurement method according to an embodiment of the present invention.

In operation 601, a girth measurement device may unwind a tape wound around a trunk of a tree from a wireless communication tag apparatus to measure a girth of the tree, while maintaining a constant tension of the tape. That is, the girth measurement device may wind around the trunk while unwinding the tape included in the girth measurement device according to growth of the tree, and may rewind the tape from the trunk when a link of the tape is separated from the wireless communication tag apparatus.

In operation 602, the girth measurement device may determine a number of winding of a winder according to an unwound length of the tape unwound from the trunk according to growth of the tree. Here, the girth measurement device may rewind the tape using the winder included in the girth measurement device when the tape is unwound from the tree.

In operation 603, the girth measurement device may determine the girth of the tree based on the number of winding. The girth measurement device may convert the number of winding into a growth length of the girth based on a girth of the winder according to the number of winding. Here, the growth length may refer to the measured girth.

The above-described embodiments of the present invention may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of the embodiments, or they may be of the kind well-known and available to those having skill in the computer software arts.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A wireless communication tag apparatus comprising:
a girth measurement device to measure a girth of a tree using an unwound length of a tape wound around a trunk of the tree, the tape unwound according to growth of the tree; and
a wireless communication device to transmit the measured girth to a wireless communication reader.

2. The wireless communication tag apparatus of claim 1, further comprising:
a winder to rewind the tape when the tape is unwound from the trunk of the tree according to growth of the tree while maintaining a constant tension of the tape; and
a calculator to calculate the girth of the tree based on the unwound length of the tape.

3. The wireless communication tag apparatus of claim 2, wherein the girth measurement device comprises a tape adapted to be wound around the trunk of the tree, and
wherein one side of the tape is connected to the winder, and another side of the tape is connected to the wireless communication tag apparatus.

4. The wireless communication tag apparatus of claim 2, wherein the calculator determines a number of winding of the winder according to the unwound length of the tape and converts the number of winding into a growth length of the tree.

5. The wireless communication tag apparatus of claim 4, wherein the calculator determines the number of winding of the winder based on a girth of the winder measured with reference to a starting position of winding of the tape on the winder.

6. The wireless communication tag apparatus of claim 1, wherein the girth of the tree is periodically measured according to a growth speed of the tree, and the measured girth is used as information to manage a growth process of the tree.

7. The wireless communication tag apparatus of claim 1, wherein the wireless communication device transmits the measured girth of the tree in response to at least one of a transmission period included in girth measurement setup information set when the wireless communication tag apparatus is attached to the tree and a transmission command of the wireless communication reader.

8. A girth measurement device comprising:
a winder to rewind a tape wound around a trunk of a tree when the tape is unwound from a wireless communication tag apparatus to measure a girth of the tree, while maintaining a constant tension of the tape; and
a calculator to calculate the girth of the tree based on an unwound length of the tape.

9. The girth measurement device of claim 8, wherein the tape is wound around the winder by a first length and around the tree by a second length.

10. The girth measurement device of claim 9, wherein the first length refers to a length of the tape provided to be wound around the trunk according to a growth of the tree, and
wherein the second length refers to a length of the tape wound around the trunk according to the growth of the tree and unwound to calculate the girth of the tree.

11. The girth measurement device of claim 8. wherein the calculator determines a number of winding according to the unwound length of the tape and converts the number of winding into a growth length of the tree.

12. The girth measurement device of claim 11, wherein the calculator determines the number of winding of the winder based on a girth of the winder measured with reference to a starting position of winding of the tape on the winder.

13. The girth measurement device of claim 8, wherein the girth of the tree is periodically measured according to a growth speed of the tree, and the measured girth is used as information to manage a growth process of the tree.

14. The girth measurement device of claim 8, wherein the girth measurement device is built in the wireless communication tag apparatus, and
wherein the wireless communication tag apparatus transmits a growth length of the tree to a wireless communication reader.

15. A girth measurement method comprising:
allowing a tape wound around a trunk of a tree to be unwound from a wireless communication tag apparatus to measure a girth of the tree while maintaining a constant tension of the tape;
determining a number of winding of a winder according to an unwound length of the tape; and
calculating the girth based on the number of winding.

16. The girth measurement method of claim 15, wherein the tape is wound around the winder by a first length and around the tree by a second length.

17. The girth measurement method of claim 16, wherein the first length refers to a length of the tape provided to be wound around the trunk according to a growth of the tree, and
wherein the second length refers to a length of the tape wound around the trunk according to the growth of the tree and unwound to calculate the girth of the tree.

18. The girth measurement method of claim 15, wherein the calculating of the girth comprises converting the number of winding into a growth length of the tree based on the number of winding.

19. The girth measurement method of claim 15, wherein the girth measurement device determines the number of winding of the winder based on a girth of the winder measured with reference to a starting position of winding of the tape on the winder.

20. The girth measurement method of claim 15, wherein the girth of the tree is periodically measured according to a growth speed of the tree, and the measured girth is used as information to manage a growth process of the tree.
